(19) United States
(12) Patent Application Publication
(10) Pub. No.: US 2005/0233246 A1
(43) Pub. Date: Oct. 20, 2005

(54) Novel optical storage materials, methods of making the storage materials, and methods for storing and reading data

(76) Inventors: Eugene Boden, Scotia, NY (US); Michael Jeffrey Mclaughlin, Albany, NY (US); Brian Lee Lawrence, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/826,837

(22) Filed: Apr. 16, 2004

(51) Int. Cl. G03H 1/04

(52) U.S. Cl. 430/270.11

(57) ABSTRACT

Holographic storage media including a polymeric binder, a photoactive monomer, a photo-initiator, and a stable organic or organometallic dye material are described. The dye may be covalently attached to the polymeric binder, the photoactive monomer, or both. Data may be written into the holographic storage media using light of one wavelength and read using light of a different or the same wavelength.

### BACKGROUND

Optical data storage technology has largely evolved on the basis of surface storage phenomena. For example, in one of the most common optical storage formats, the compact disc, or CD, the data is encoded as minute variations in the surface of a recording medium. The data are read using optical means (usually a laser), similar to the way in which data recorded in a magnetic medium are readable with a magnetically-sensitive head, or data recorded in a vinyl medium are readable with a needle. Unlike vinyl recording, however, in optical storage the data are usually stored digitally.

In surface-based optical data storage systems, each bit of data occupies a specific physical location in the storage medium. The data density of the optical media is therefore limited by physical constraints on the minimum size of a recording spot. Alternative to surface-based formats are multi-layer systems which increase data density by applying surface-based storage techniques to individual layers that are then combined to create a multiple-layer media. However, the fundamental limitations of the partially or fully reflective layers limits the multi-layer media format to no more than about four or five layers per side.

An alternative approach to the traditional surface-based storage systems is volumetric storage technology, in which the full volume of a storage medium is used to increase data capacity. The two most common techniques for volumetric storage are multi-layer and holographic storage. The multi-layer approach resembles the multiple-layer CD/DVD approach, except that the data is written and retrieved using various optical phenomena that are sensitive to focused beams, so that various depths in the medium can be addressed by changing the depth of the focus. This technique eliminates the complexities of fabricating and assembling multiple layers and, furthermore, removes the limitation on the number of layers, making the data capacity a function of the focusing capabilities of the optical system and the media thickness.

Holographic storage, on the other hand, is data storage throughout the volume of the medium via three dimensional interference patterns. In the holographic recording process, laser light from two beams, a reference beam and a signal beam containing encoded data, meet within the volume of a photosensitive holographic medium. The interference pattern from the superposition of the two beams results in a change or modulation of the refractive index of the holographic medium. This modulation within the medium serves to record both the intensity and phase information from the signal. The recorded intensity and phase data are then retrieved by exposing the storage medium to the reference beam alone. The reference beam interacts with the stored holographic data and generates a reconstructed signal beam that is proportional to the initial signal beam used to store the holographic image. For information on conventional volume holographic storage, see, for example, U.S. Pat. Nos. 4,920,220, 5,450,218, and 5,440,669. In addition, non-destructive readout of volume holographic memories may be accomplished by using different wavelengths in the recording and readout phases. See U.S. Pat. No. 5,438,439.

Typically, volume holographic storage is accomplished by having data written in the holographic medium in parallel, on arrays or “pages” containing one to 1×10⁶ or more bits. Each bit is generally stored as a part of the interference pattern that generates the modulation in refractive index over the volume of the holographic storage medium in a given spot. Therefore it is of no consequence to speak in terms of the spatial “location” of a single bit. Instead, each bit can be thought of as consuming some small portion of the overall index modulation. A storage medium that can support large index changes and can be fabricated into thick media may consequently store multiple pages within the volume of the holographic medium by angular, wavelength, phase-code or related multiplexing techniques.

The heart of any holographic storage system is the medium. Early holographic storage demonstrations used inorganic photorefractive crystals, such as lithium niobate, in which incident light can create refractive index changes. These index changes are due to the photo-induced creation and subsequent trapping of electrons leading to an induced internal electric field that ultimately modifies the index through the linear electro-optic effect. However, the efficiency of these materials is relatively poor and thick crystals are required to observe significant effects.

More recent work has led to the development of organic polymers that can sustain large refractive index changes due to optically induced polymerization processes. A holographic recording medium comprising an acid generator capable of producing an acid upon exposure to actinic radiation, a binder, and a monomer capable of undergoing cationic polymerization in the presence of the acid is described in U.S. Pat. No. 5,759,721. Initially, the mixture has a uniform refractive index based on the weight fraction of each component and their individual refractive indices. Acid-initiated cationic polymerization of the monomers leads to the formation of a polymer which has a refractive index different from that of the binder. Monomer molecules diffuse into the region of polymerization, while binder material diffuses out because it does not participate in the polymerization. Spatial separation of the photopolymer formed from the monomer and the binder provides the refractive index modulation required to form a hologram. Other examples of photopolymer systems for use as holographic storage systems are described in U.S. Pat. No. 6,221,536, WO 99/26112 and WO 02/19040.

One disadvantage of these previously described photopolymer systems is that the change in the refractive index between the photopolymer and the binder may not be substantial enough to create a large contrast between the regions of the photopolymer and the binder. One approach to enhance the differences in refractive indices between the photopolymer and the binder is to blend highly refractive nanoparticles into the binder material (Suzuki et al. “Holographic recording in TiO₂ nanoparticle-dispersed methacrylate photopolymer films” Applied Physics Letters, vol. 81, pp. 4121-4123 (2002)). Polymerization of the monomers pushes the nanoparticles away from the photopolymer, creating a large refractive index contrast between the polymerized regions and the binder regions. Problems with the use of such a heterogeneous system is that upon heavy loading, particularly of particles larger than about 100 nm, the materials may become opaque and lose optical quality. Another problem is that the naturally occurring aggregation of the particles can lead to a reduction in the mechanical properties of the material.

There thus remains a need for improved photopolymer systems suitable for holographic data storage materials.

### SUMMARY

A holographic storage medium comprises a polymeric binder; a photoactive monomer; a photo-initiator; and a stable, organic or organometallic dye; wherein the dye is present in an amount sufficient to enhance the refractive index difference between a region of polymeric binder and a region of photopolymer.

A method for producing a holographic storage medium comprises forming a substrate comprising a polymeric binder, a photoactive monomer, a photo-initiator, and a stable organic or organometallic dye; and writing data into the substrate with an information-carrying light pattern, at a wavelength suitable to activate the photo-initiator and to polymerize at least a portion of the photoactive monomer to form the holographic storage medium; wherein the dye is present in an amount sufficient to enhance the refractive index difference between a region of polymeric binder and a region of photopolymer.

In another aspect, a method for storing data in a holographic storage medium comprises forming a storage medium comprising a polymeric binder, a photoactive monomer, a photo-initiator, and a stable, organic or organometallic dye; and illuminating the storage medium with a signal beam possessing data and a reference beam simultaneously for storing a hologram of the data contained by the signal beam in the optical storage medium; wherein at least a portion of the photoactive monomer undergoes polymerization upon exposure to the signal beam thereby, forming a hologram in the storage medium; wherein the dye is present in an amount sufficient to enhance the refractive index difference between a region of polymeric binder and a region of photopolymer.

In yet another aspect, an optical reading method comprises forming a storage medium comprising a polymeric binder, a photoactive monomer, a photo-initiator, and a stable organic or organometallic dye; illuminating the storage medium with a signal beam possessing data and a reference beam simultaneously for storing a hologram of the data contained by the signal beam in the optical storage medium, wherein at least a portion of the photoactive monomer undergoes polymerization upon exposure to the signal beam thereby forming a hologram in the storage media; illuminating the holographic storage medium with a read beam; and reading the data contained by diffracted light from the hologram; wherein the dye is present in an amount sufficient to enhance the refractive index difference between a region of polymeric binder and a region of photopolymer.

### BRIEF DESCRIPTION OF THE DRAWINGS

FIG. 1 is a depiction of a digital holographic storage setup for writing data (FIG. 1 (a)) and reading stored data (FIG. 1 (b)).

FIG. 2 is a depiction of a diffraction efficiency setup for writing plane wave holograms (FIG. 2(a)) and measuring diffracted light (FIG. 2(b)).

FIG. 3 is a depiction of a holographic plane-wave characterization system.

### DETAILED DESCRIPTION

The terms “a” and “an” herein do not denote a limitation of quantity, but rather denote the presence of at least one of the referenced item.

Optical data storage media for use in holographic data storage and retrieval are described. These holographic storage media are formed from a substrate comprising a polymeric binder, a photoactive monomer, a photo-initiator, a stable, organic dye, and optionally a sensitizer. As used herein, the term organic dye also includes organometallic dyes. By stable, it is meant that the dyes do not undergo appreciable degradation and/or reaction when exposed to visible light as well as ambient levels of UV light. The dye may possess optical properties selected and utilized on the basis of, at least in part, the separation between the maximum absorption of the dye and the desired wavelength or wavelengths to be used for writing and/or reading the data. In one embodiment, the dye is dispersed in the polymeric binder. In an alternative embodiment, the dye is covalently attached to the photoactive monomer, the polymeric binder, or both. One or more photoactive dyes may be employed.

In a storage medium comprising a photoactive monomer and a polymeric binder, upon photo-initiated polymerization of at least a portion of the photoactive monomer, binder molecules diffuse out of the region of polymerization, leading to a physical separation between regions of photopolymer and regions of polymeric binder. There is an inhomogeneous region caused by the refractive index difference between the regions of photopolymer and the regions of polymeric binder in which the data may be stored. Thus, polymerization of at least a portion of the photoactive monomer provides an optically readable datum within the holographic storage medium. The information stored in the inhomogeneous region can be reconstructed by shining a single beam of light through the region.

It has been unexpectedly discovered that the refractive index difference between the photopolymer regions and polymeric binder regions may be enhanced by employing one or more stable, organic dyes which may optionally be associated with the photopolymer region, the polymeric binder region, or both. Because the dye molecules are associated with a particular region, they enhance the refractive index difference between the regions of photopolymer and regions of polymeric binder. The refractive index enhancement produced by the dye is based upon the relationship between absorption and refractive index as explained by the Kramers-Kronig relationship. The Kramers-Kronig relationship relates to a general property of complex functions describing physical reality that, under certain very general conditions, the real and imaginary part are directly related. One consequence is that if there is an absorption line or band in a material, then the refractive index will be decreased at wavelengths below resonance and increased at wavelengths above resonance. Thus, depending upon the position of the absorption line or band of the dye relative to the read laser wavelength, the dye molecules may exhibit resonantly enhanced refractive indices. These enhanced refractive indices may lead to an increase in the dynamic range of the storage material, that is, the number of holograms and amount of information that may be stored.

The substrate comprises a polymeric binder, a photoactive monomer, a photo-initiator, a stable, organic dye, and optionally a sensitizer. The polymeric binder may be a material having sufficient optical quality, e.g., low scatter, low birefringence, and negligible losses at the wavelengths of interest, to render the data in the holographic storage material readable. In addition, the polymeric binder should be one that does not inhibit the polymerization of the photoactive monomer employed. However, the polymeric binder should be capable of withstanding the processing parameters (e.g., inclusion of the dye formation of the storage medium) and subsequent storage conditions.

The polymeric binder may have a glass transition temperature of about −130° C. to about 150° C., or higher. In addition, to provide a holographic medium that exhibits relatively low levels of light scatter, the polymeric binder and photoactive monomer, as well as the other components, are advantageously compatible. Polymers are considered to be compatible if a blend of the polymers is characterized, in a 90° light scattering experiment using the wavelength used for hologram formation, by a Rayleigh ratio (R 90°) less than 7×10⁻³ cm⁻¹. The Rayleigh ratio is a known property, and is defined as the energy scattered by a unit volume in the direction θ, per steradian, when a medium is illuminated with a unit intensity of unpolarized light. The Rayleigh ratio may be obtained by comparison to the energy scatter of a reference material having a known Rayleigh ratio. Polymers that are considered to be miscible, e.g., according to tests such as exhibition of a single glass transition temperature, will typically be compatible as well, but polymers that are compatible will not necessarily be miscible. It is possible to increase compatibility of a polymeric binder with other components, such as a monomer, by appending to the polymeric binder groups that resemble such other components, e.g., a functional group from a photoactive monomer, or by appending to the polymeric binder a group that displays a favorable enthalpic interaction, such as hydrogen bonding, with such other components. It is also possible to make such modifications to various components of a material, to increase the overall compatibility of the individual components.

Suitable binders include polymethacrylates such as polymethyl methacrylate and copolymers of methyl methacrylate with the other acrylic alkyl ester, polysiloxanes, polysiloxane copolymers, chlorinated polyethylene, copolymers of vinyl chloride with acrylonitrile, polyvinyl acetate, polyvinyl alcohol, polyvinyl formal, polyvinyl butyral, polyvinyl pyrrolidone, ethyl cellulose, acetyl cellulose, and combinations comprising one or more of the foregoing binders. The polymeric binder may contain a reactive group (e.g. cationic polymerizable group, etc.) at a side chain or main chain thereof. The physical, optical, and chemical properties of a polysiloxane binder, for example, can all be adjusted for optimum performance in the recording medium inclusive of, for example, dynamic range, recording sensitivity, image fidelity, level of light scattering, and data lifetime. Suitable polysiloxanes include, for example, poly(methyl methyl siloxanes); poly(methyl phenyl siloxanes), and oligomers thereof, such as 1,3,5-trimethyl-1,1,3,5,5-pentaphenyltrisiloxane; and poly(acryloxypropyl)methyl siloxane. Examples are sold by Dow Corning Corporation under the tradename DOW Corning 705 (a trimer) and DOW Corning 710. Suitable polyacrylates include, for example, poly(butyl methacrylate).

The photoactive monomer is a monomer, an oligomer, or a combination thereof, capable of undergoing photoinitiated polymerization such that a hologram is formed. It is possible to use cationically polymerizable systems such as vinyl ethers, alkenyl ethers, allene ethers, ketene acetals, and epoxies. Other suitable photoactive monomers include those which polymerize by a free-radical reaction, e.g., molecules containing ethylenic unsaturation such as acrylates, methacrylates, methyl methacrylates, acrylamides, methacrylamides, styrene, substituted styrenes, vinyl naphthalene, substituted vinyl naphthalenes, and other vinyl derivatives. Free-radical copolymerizable pair systems such as vinyl ether mixed with maleate and thiol mixed with olefin are also suitable.

Suitable epoxide monomers include cyclohexene oxide, cyclopentene oxide, 4-vinylcyclohexene oxide and derivatives such as silylethyl derivatives capable of being prepared from 4-vinylcyclohexene oxide, 4-alkoxymethylcyclohexene oxides and acyloxymethylcyclohexene oxides capable of being prepared from 4-hydroxymethylcyclohexenes, and polyfunctional epoxides such as 3,4-epoxycyclohexylmethyl, 3,4-epoxycyclohexanecarboxylate, 1,3-bis(2-(3,4-epoxycyclohexyl)ethyl)-1, 1,3,3-tetramethydisiloxane, ,2-epoxy-1,2,3,4-tetrahydronaphthalene, and combinations comprising one or more of the foregoing epoxide monomers. A suitable bis-epoxy monomer is PC-1000 available from Polyset Inc.

Another group of photoactive monomers are those in which one or more cyclohexene oxide groupings are linked to an Si—O—Si grouping. These monomers have the advantage of being compatible with polysiloxane binders. Examples of such monomers include those of the formula: 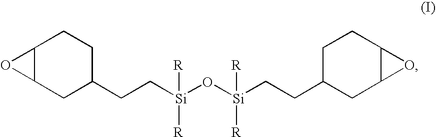
wherein each R independently is an alkyl group containing less than or equal to about 6 carbon atoms. The compound in which each group R is a methyl group is available from General Electric Company under the tradename General Electric Silicone 479-1893.

A variety of tri-, tetra- and higher polyepoxysiloxanes may be employed as the photoactive monomer. One group of such polyepoxysiloxanes are the cyclic compounds of the formula: 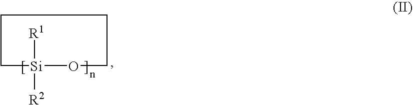
wherein each group R¹ is, independently, a monovalent substituted or unsubstituted C₁₋₁₂ alkyl, C₁₋₁₂ cycloalkyl, aralkyl or aryl group; each group R² is, independently, R¹ or a monovalent epoxy functional group having 2 to 10 carbon atoms, with the proviso that at least three of the groups R¹ are epoxy functional; and n is 3 to 10. The preparation of these cyclic compounds is described in, inter alia, U.S. Pat. No. 5,037,861; U.S. Pat. No. 5,260,999; U.S. Pat. No. 5,387,698; and U.S. Pat. No. 5,583,194. One specific useful polymer of this type is 1,3,5,7-tetrakis(2-(3,4-epoxycyclohexyl)ethyl)-1,3,5,7-tetramethyl cyclotetrasiloxane.

Suitable photoactive epoxide monomers are those of the formula:
R³Si(OSi(R⁴)₂R⁵)₃ (III),
wherein R³ is an OSi(R⁴)₂R⁵ grouping, or a monovalent substituted or unsubstituted C₁₋₁₂ alkyl, C₁₋₁₂ cycloalkyl, aralkyl or aryl group; each group R⁴ is, independently, a monovalent substituted or unsubstituted C₁₋₁₂ alkyl, C₁₋₁₂ cycloalkyl, aralkyl or aryl group; and each group R⁵ is, independently, a monovalent epoxy functional group having 2 to 10 carbon atoms. The preparation of these monomers is described in, inter alia, U.S. Pat. No. 5,169,962; U.S. Pat. No. 5,260,399; U.S. Pat. No. 5,387,698; and U.S. Pat. No. 5,442,026. One specific monomer of this type found useful in the present process is that in which R³ is a methyl group or an OSi(R⁴)₂R⁵ grouping; each group R⁴ is a methyl group, and each group R⁵ is a 2-(3,4-epoxycyclohexyl)ethyl grouping.

Another group of photoactive monomers are those of the formula:
(R⁶)₃SiO[SiR⁷R⁸O]ₚ[Si(R⁷)₂O]_{q}Si(R⁶)₃ (IV)
wherein each group R⁶ is, independently, a monovalent substituted or unsubstituted C₁₋₁₂ alkyl, C₁₋₁₂ cycloalkyl, or phenyl group; each group R⁷ is, independently, a monovalent substituted or unsubstituted C₁₋₁₂ alkyl, C₁₋₁₂ cycloalkyl, aralkyl or aryl group; each group R⁸ is, independently, a monovalent epoxy functional group having 2 to 10 carbon atoms, and p and q are integers. These monomers may be prepared by processes analogous to those described in U.S. Pat. No. 5,523,374, which generally involve hydrosilylation of the corresponding hydrosilanes with the appropriate alkene oxide using a platinum or rhodium catalyst. Specific monomers of this type are those in which each group R⁶ and R⁷ is an alkyl group, such as, for example, that in which R⁸ is a 2-(3,4-epoxycyclohexyl)ethyl grouping and p and q are about equal.

Combinations comprising one or more of the foregoing photoactive monomers may also be employed.

The recording material preferably comprises a photo-initiator for inducing polymerization of the photoactive monomer. Direct light-induced polymerization of the photoactive monomer by itself, such as by exposure to light may be difficult, particularly as the thicknesses of storage media increase. The photo-initiator, upon exposure to relatively low levels of the recording light, chemically initiates the polymerization of the photoactive monomer, avoiding the need for direct light-induced polymerization of the monomer.

One type of photo-initiator is a photoacid generator that is capable, or contains a moiety that is capable, of absorbing incident radiation at some wavelength, and, through subsequent chemical transformation, releasing at least one proton, strong proton acid, or Lewis acid. Where a photoacid generator has a low absorbance at a preferred radiation, sensitizers may be used. Sensitizers absorb, or contain a moiety that absorbs, the incident radiation at the wavelength of interest, and transfer the energy to the photoacid generator, e.g., by way of Forster transfer, electron transfer, or chemical reaction, thereby inducing reaction of the photoacid generator. For example, many photoacid generators respond to ultraviolet (UV) light, whereas visible light (e.g., 400 to 700 nm) is typically used for recording holograms. Thus, sensitizers which absorb at such visible wavelengths and transfer energy to photo-initiators may be used. Rubrene is one such sensitizer that absorbs at visible wavelengths.

It is possible for a photoacid generator to have a sensitizer moiety, or for the released proton or acid to originate on the sensitizer. It is also possible for the photoacid generator and sensitizer to be covalently bonded, which is advantageous in that it would not be necessary for the photoacid generator and sensitizer to diffuse toward each other to attain energy transfer. Such a covalently bound photoacid generator/sensitizer, however, would be extremely sensitive to the radiation absorbed by the sensitizer, i.e., would be chemically unstable with respect to the radiation. It is further possible for the photoacid generator and/or sensitizer to be bound to the polymeric binder and/or the photoactive monomer. The photoacid generator and sensitizer may be compatible with other components of the material, as discussed above. Examples of suitable photoacid generators include cationic photoinitiators such as diazonium, sulfonium, phosphonium and iodonium salts. In particular, alkoxyphenyl phenyliodonium salts, such as p-octyloxyphenyl phenyliodonium hexafluoroantimonate, ditolyliodonium tetrakis(pentafluorophenyl) borate, diphenyliodonium tetrakis(pentafluorophenyl)borate, tolylphenyliodonium is tetrakis(pentafluorophenyl)borate and cumyltolyliodonium tetrakis(pentafluorophenyl)borate, and combinations comprising one or more of the foregoing photo-initiators have been found to be useful. These salts absorb predominantly in the UV portion of the spectrum, and are therefore typically sensitized to allow use of the visible portion of the spectrum. An example of a visible cationic photoinitiator is (η 6-2,4-cyclopentadien-1-yl) (η 6-isopropylbenzene)-iron(II) hexafluorophosphate, available commercially from Ciba as Irgacure 261, which may be employed alone or in combination with the foregoing photoinitiators. Another suitable photo-initiator is bis(eta-5-2,4-cyclopentadien-1-yl)bis[-2,6-difluoro-3-1H-pyrrol-1-ylphenyl]titanium available as Irgacure 784 available from Ciba.

In the absence of a sensitizer, iodonium salts are typically sensitive to radiation in the far ultra-violet region, below about 300 nm, and the use of far ultra-violet radiation is inconvenient for the production of holograms because, for a given level of performance, ultra-violet lasers are substantially more expensive than visible lasers. However, it is well known that, by the addition of various sensitizers, iodonium salts can be made sensitive to various wavelengths of radiation to which the salts are not substantially sensitive in the absence of the sensitizer. In particular, iodonium salts can be sensitized to visible radiation with sensitizers using certain aromatic hydrocarbons substituted with at least two alkynyl groups, a specific sensitizer of this type being 5,12-bis(phenylethynyl)naphthacene. This sensitizer renders iodonium salts sensitive to the 514 nm radiation from an argon ion laser, and to the 532 nm radiation from a frequency-doubled YAG laser, both of which are convenient sources for the production of holograms.

Where the photoactive monomer is not polymerized by acid catalysis, a variety of other types of photo-initiators known to those skilled in the art and available commercially are suitable for polymerization. To avoid the need for sensitizers, it is advantageous to use a photo-initiator that is sensitive to light in the visible part of the spectrum, particularly at wavelengths available from conventional laser sources, e.g., the blue and green lines of Ar⁺(458, 488, 514 nm) and He—Cd lasers (442 nm), the green line of frequency doubled YAG lasers (532 nm), and the red lines of He—Ne (633 nm) and Kr⁺lasers (647 and 676 nm). One advantageous free radical photo-initiator is bis(η-5-2,4- cyclopentadien-1-yl)bis[2,6-difluoro-3-(1H-pyrrol-1-yl)phenyl]titanium, available commercially from Ciba as CGI-784. Another visible free-radical photo-initiator (which requires a co-initiator) is 5,7,diiodo-3-butoxy-6-fluorone, commercially available from Spectra Group Limited as H-Nu 470. Free-radical photo-initiators consisting of dye-hydrogen donor systems are also possible. Examples of suitable dyes include eosin, rose bengal, erythrosine, and methylene blue, and suitable hydrogen donors include tertiary amines such as n-methyl diethanol amine.

The storage medium comprises a stable, organic dye. As used herein the term organic dye includes organometallic dyes. Suitable dyes are those that have strong absorptions in the visible light range (i.e., 400 nm to 700 nm) and/or the near-infrared light range (i.e., 700 nm to 1200 nm). In some embodiments, suitable dyes may not have strong absorptions at the read and write wavelengths (e.g., 532 nm or 633 nm) of the lasers employed for holographic optical data storage. By stable, it is meant that the dyes do not undergo appreciable degradation or reaction when exposed to visible light as well as ambient levels of UV light. The dyes should be stable to decomposition and physical and/or chemical changes at the read/write wavelengths and/or during normal storage conditions. If two or more dye molecules are employed, dye molecules with absorption bands in different regions of the spectrum may be used. While the organic materials used in the photoactive monomer and polymeric binder are typically colorless and have refractive indices of about 1.4 to about 1.6, the dye molecules may have resonance enhanced refractive indices of as much as or greater than 2 or less than 1.4, depending upon the position of the absorption band of the dye molecule relative to the laser wavelengths employed.

Suitable dyes may be selected on the basis of their absorption maxima, solubility, and compatibility with other components of the storage medium. A suitable dye may have an absorption maximum at a wavelength that is different from the wavelengths used to write and read the data. The dye may have an absorption maximum at a wavelength that is greater than the wavelength of light used to write data onto the storage medium (i.e., the wavelength used to polymerize the photoactive monomer). For example, if the wavelength of light used to write data on the storage medium is 532 nm, the dye may have an absorption maximum at a wavelength greater than 532 nm. In one embodiment, the dyes have absorption maxima of greater than 400 nm. In another embodiment, the dyes have absorption maxima of greater than 590 nm. Alternatively, the dye may have an absorption maximum at a wavelength less than the wavelength of light used to write the data onto the storage medium (e.g., less than 532 nm). In practice, the difference between the absorption maximum of the dye and the wavelength used to polymerize the photoactive monomer may be optimized empirically based at least in part on the width of the maximum absorption peak of the dye.

Suitable dye materials include organic dyes having two or more aromatic rings joined by a bridging double bond. Suitable dye materials include stable stilbene derivatives (including extended stilbenes), azo, and other dye molecules, such as organic nonlinear optical (NLO) materials. Suitable stilbenes include, for example, 4-hydroxy-4′-nitrostilbene and 4-[N-(2-methacryloylethyl)-N-methylamino]-4′-nitrostilbene. Suitable dyes may be selected, for example, from the Molecular Probes catalog or from Sigma-Aldrich. Other suitable dyes are those which have absorption bands at greater than 400 nm such as indigo and Sudan I.

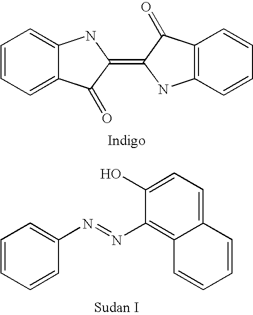

A suitable organometallic dye is bis[5-(2′-methyl-4′-diethylaminophenylimino)quinoline-8-one] nickel(II) diperchlorate, illustrated below:

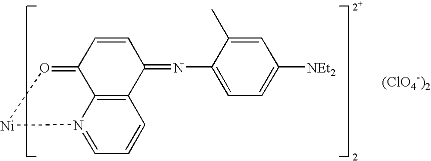

A free dye molecule may be mixed into the storage medium. Without being held to theory, it is believed that the dye will remain as part of the polymeric binder phase, not as part of the photopolymer phase. Alternatively or in addition, the dye molecule may be covalently attached to the photoactive monomer, the polymeric binder, or both. Attachment of the dye molecule to the photoactive monomer and/or the polymeric binder may enhance the refractive index difference between the photopolymer regions and the polymeric binder regions. In addition, attachment of the dye molecule to the photoactive monomer and/or the polymeric binder can improve the compatibility of the dye molecules with the other components. If attached to the photoactive monomer, the dye molecule will move to the region of polymerization upon exposure to light. If attached to the polymeric binder, the dye molecules will diffuse out of the region of polymerization upon exposure to light. The large refractive index change created by movement of the dye molecules into or away from the region of polymerization (e.g. where data is written onto the material holographically) provides a large difference in refractive index between the regions of photopolymer and the regions of polymeric binder. A greater difference in refractive index leads to an increased dynamic range for the recording material, which in turn is related to the number of holograms and the amount of information which may be stored. Each hologram which is stored causes and incremental change in the refractive index, and partially consumes monomers, until the dynamic range afforded by the system is exhausted. The sensitivity and speed of writing information may also be retained with these new recording media.

To facilitate attachment of the dye molecule to the photoactive monomer and/or the polymeric binder, the dye molecule may comprise a reactive functional group such as, for example, a phenolic oxygen, a primary amine, a secondary amine, and combinations comprising one or more of the foregoing functional groups. Reaction of the functional group may be employed to connect the dye molecule to a linker. A dye molecule comprising a covalently attached linker may then be covalently attached to a photoactive monomer and/or a binder. Suitable linkers may comprise, for example, acids, enolates, halogens, silyl groups (—SiR₃₋ₓHₓ), isocyanate, cyanate, thiocyanate, epoxy, vinyl silyls, silyl hydrides, silyl halogens, mono-, di- and trihaloorganosilane, phosphonates, organometalic carboxylates, vinyl groups, allyl groups, unsaturated carbon-containing groups, and combinations comprising one or more of the foregoing linkers. An additional reaction, such as metathesis, may be used to attach the dye:linker molecule to the polymer (or monomer), which is terminated with the appropriate functional group to receive the linker. In a similar strategy, the linker can be attached to the polymeric binder and/or photoactive monomer, and the dye added in the second reaction. Exemplary linkers and linking reactions are illustrated below:

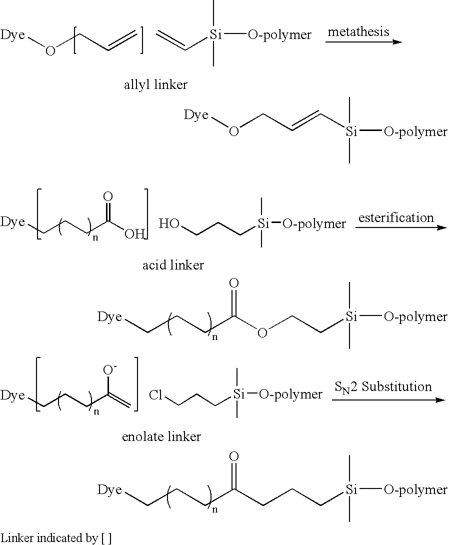

An allyl linker, for example, may be covalently linked to a dye molecule containing a phenolic oxygen (e.g., 4-hydroxy-4′-nitrostilbene) by reacting the dye and allyl bromide in the presence of an acid such as, for example, NaH. The functionalized dye may then be hydrosilated in the presence of a Pt catalyst such as Pt(0) and a hydride-terminated siloxane monomer or polysiloxane. An example of such a reaction is shown below:

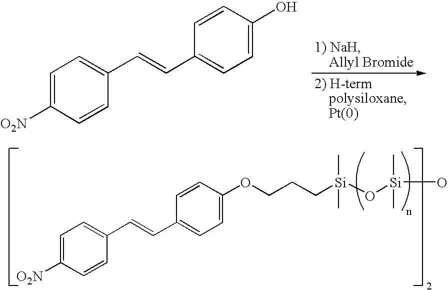

The proportions of photo-initiator, polymeric binder and photoactive monomer or oligomer in the holographic storage medium may vary rather widely, and the optimum proportions for specific components and methods of use can readily be determined empirically by skilled workers. However, in general, the storage medium comprises about 1 to about 10 percent by weight of the photo-initiator, about 10 to about 89 percent by weight of the polymeric binder and about 10 to about 89 percent by weight of the photoactive monomer or oligomer. While there is no particular limitation on the maximum amount of dye, the concentration of dye should be in an amount that does not significantly impact the mechanical properties of the storage medium. The dye is used in an amount sufficient to produce the desired refractive index difference between the photopolymer regions and the polymeric binder regions, such as about 0.1 percent by weight to about 75 percent by weight of the storage medium. Higher amounts such as up to about 90 wt % may be possible under certain circumstances.

A storage medium may be formed by adequately supporting the substrate (i.e., the polymeric binder, photoactive monomer, photo-initiator system, and dye), such that holographic writing and reading is possible. Fabrication of the storage medium may involve depositing the substrate between two plates using, for example, a gasket to contain the substrate. The plates may be glass, but it is also possible to use other materials transparent to the radiation used to write data, e.g., a plastic such as polycarbonate or poly(methyl methacrylate). It is possible to use spacers between the plates to maintain a desired thickness for the storage medium. The storage material also may be supported in other ways. For example, the binder precursor/photoimageable system mixture may be disposed in the pores of a support, e. g., a nanoporous glass material such as Vycor, prior to binder cure. A stratified medium is also possible, i.e., a medium containing multiple supports, e.g., glass, with layers of storage material disposed between the supports. The medium may then be used in a holographic system such as discussed previously.

Once formed, the holographic storage media may be subjected to processes known to those skilled in the art for holographic data storage. Holographic data storage is one of several techniques that may use the full volume of a storage material to maximize data density (as opposed to surface storage as is used in CD and DVD style systems). In the holographic storage process, the data is used to generate an optical interference pattern, which is subsequently stored in the holographic storage media.

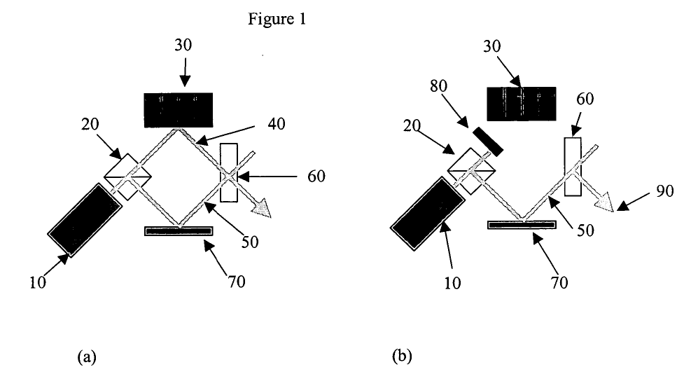

An example of a suitable holographic data storage process to create holographic storage media of the present disclosure is set forth in FIG. 1a. In this configuration, the output from a laser 10 (532 nm) is divided into two equal beams by beam splitter 20. One beam, the signal beam 40, is incident on a form of spatial light modulator (SLM) or deformable mirror device (DMD) 30, which imposes the data to be stored on the signal beam 40. This device is composed of a number of pixels that can block or transmit the light based upon input electrical signals. Each pixel can represent a bit or a part of a bit (a single bit may consume more than one pixel of the SLM or DMD) of data to be stored. The output of the SLM or DMD 30 is then incident on the storage material 60. The second beam, the reference beam 50, is transmitted all the way to the storage material 60 by reflection off mirror 70 with minimal distortion. The two beams are coincident on the same area of the storage material 60 at different angles. The net result is that the two beams create an interference pattern at their intersection in the material. The interference pattern is a unique function of the data imparted to the signal beam 40 by the SLM or DMD 30. At least a portion of the photoactive monomer undergoes polymerization, while the polymeric binder diffuses out of the region of polymerization. The difference in refractive index between the region of photopolymer and the region of polymeric binder is enhanced by the presence of a dye in one or both regions. This photopolymerization leads to a modification of the refractive index in the region exposed to the laser light and fixes the interference pattern that is created into the holographic storage media, effectively creating a grating in the storage material 60.

For reading the data, as depicted in FIG. 1b, the grating or pattern created in the storage material 60 is simply exposed to the reference beam 50 in the absence of the signal beam by blocking same with a shutter 80 and the data is reconstructed in a recreated signal beam 90.

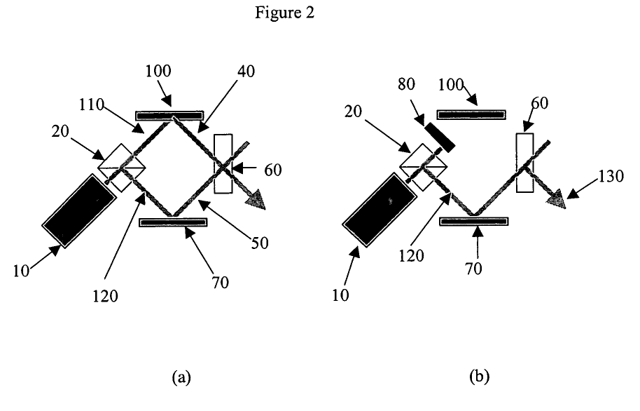

In order to test the characteristics of the material, a diffraction efficiency measurement can be used. A suitable system for these measurements is shown in FIG. 2a. This setup is very similar to the holographic storage setup; however, there is no SLM or DMD, but instead, a second mirror 100. The laser 10 (e.g., 532 nm) is split into two beams 110 and 120 that are then interfered in the storage material 60 creating a plane wave grating. As depicted in FIG. 2b, one of the beams is then turned off or blocked with shutter 80 and the amount of light diffracted by the grating in storage material 60 is measured. The diffraction efficiency is measured as the power in the diffracted beam 130 versus the amount of total power incident on the storage material. More accurate measurements may also take into account losses in the material due to reflections at the surfaces and absorption in the volume

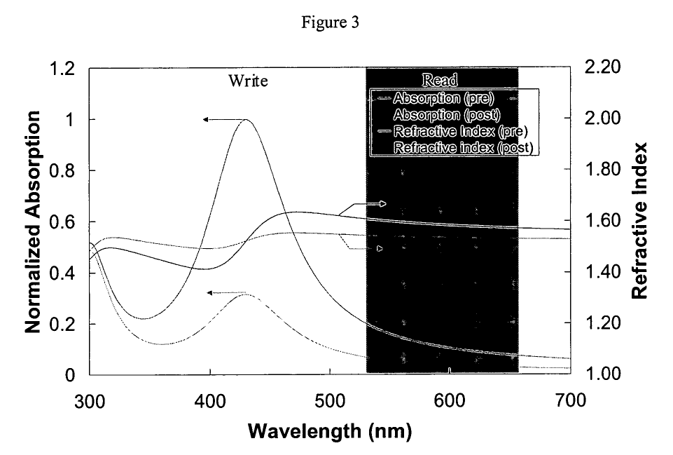

Alternatively, a holographic plane-wave characterization system may be used to test the characteristics of the material, especially multiplexed holograms. Such a system can provide the M/# for a given sample, which is the metric used to characterize the ultimate dynamic range or information storage capacity of the sample as measured by the maximum number and efficiency of multiplexed holograms stored in the material. A suitable system for these measurements is shown in FIG. 3. In this setup the output from laser 10 (Coherent, Inc DPSS 532) is passed through shutter 20 for read/write control, and then through a combination of a half-wave plate, 30, and polarizing beam-splitter, 40, for power control. The light is then passed through a two-lens telescope, 50 (the two double-ended arrows) to adjust the beam size, reflected off mirror 51, and then mirror 52 to transport the beam into the measurement area. The light is then passed through a second half-wave plate, 31, and a second polarizing beam splitter, 41, to split the beam in two and to control the power in each of the two beams. The beam reflected off of the beamsplitter is then passed through a second shutter, 21, which enable independent on/off control of the power in the first beam. The first beam is then reflected off of a mirror, 53, and is incident on the sample, 60 mounted on a rotation stage 80. The light from the first beam transmitted through the sample is collected into detector 70. The second beam is passed through a third half wave plate, 32, to rotate its polarization into the same direction as the first beam and then through shutter 22 to provide on/off control of the second beam. The second beam is then reflected off of mirror 54 and is incident on the sample. For measuring the in situ dynamic change in the sample during exposure, a second laser, 11, is passed through a two-lens telescope, 55, reflected of mirror 56 and mirror 57 and is then coincident on the sample at the same locations as the first and second beams. The diffracted beam is then collected into detector 71.

The holographic storage media may be utilized in conjunction with a process whereby light of one wavelength from a laser is utilized to write the data into the holographic storage media, while light of the same or a different wavelength is utilized to read the data from the holographic storage media. For the holographic storage media of the present disclosure, a refractive index change is created by using a writing laser wavelength that induces photopolymerization of the photoactive monomer. Thus, the wavelength employed for writing the data is a function of the photopolymer system and not the dye. The dye(s) essentially enhance the refractive index contrast between regions of photopolymer and regions of binder once the data has been written.

Once the data has been written onto the holographic storage medium, a larger, broad area of the storage medium may be exposed to a wavelength of light suitable to react with the remaining unreacted photo-initiator and the polymerize any remaining unpolymerized photoactive monomer. The broad area may be larger than the size of the stored hologram to the size of the entire storage medium. This curing step may minimize movement of the components of the storage medium which would negatively impact the stored hologram. The method may thus further comprise exposing at least a portion of the storage medium having an area larger than the hologram to a wavelength of light sufficient to react an unreacted photo-initiator and to polymerize an unpolymerized photoactive monomer.

In constructing the holographic storage media, one can select a dye material and a wavelength of light that would result in a desired absorption at the wavelength of light being used. While the dye does not contribute to the writing process, strong absorption of the dye (i.e., an absorption maximum) near the wavelength at which data is written is not expected to enhance data storage and, in fact, may reduce the efficiency of data writing. It may, however, be desirable to have some absorption of the dye at or near the data writing wavelength. This is because the closer the wavelength is to the absorption maximum of the dye, the greater the refractive index contrast. Too great of a dye absorbance, however, can interfere with the linearity of the volumetric grating (i.e., the interference pattern that extends from the front to the back of the data storage medium) that is formed upon writing of data. Too little absorption may reduce the refractive index contrast provided by the dye. The balance between the refractive index of the dye and the wavelengths of light employed may be determined empirically. As a general rule, the upper limit of the absorbance of the dye at the writing wavelength may be about 30% to 70% of the maximum absorbance of the dye. In one embodiment, the upper limit of the absorbance of the dye at the reading wavelength may be 40% to 60% of the maximum absorbance of the dye. Alternatively, the absorbance of the dye at the writing wavelength may be zero.

As one skilled in the art will appreciate, different molecules will have widely differing absorption profiles (broader, narrower, etc.). Thus, the wavelengths utilized for writing and reading the holographic storage media of the present disclosure will depend upon the light source, the photo-initiator, the photoactive monomer, and the dye material. Wavelengths suitable for writing data into the holographic storage media can vary depending upon both the substrate and dye material used, and can be about 375 nm to about 830 nm. In another embodiment, the wavelength for writing data is about 400 nm to about 550 nm.

The reading wavelength may be the same as, or different from, the writing wavelength. In one embodiment, the reading and writing wavelengths are the same. As with the writing wavelength, absorbance of the dye at the reading wavelength may result in a reduction in signal at the detector and may limit the ability of the material to provide suitable data reconstruction. Unlike the writing process, there are no concerns about the linearity of the volumetric grating in the reading process. As with the writing process, selection of the dye is based upon the refractive index contrast which determines the amount of signal generated and the minimum absorption to reduce loss of signal at the detector. Dye absorption levels similar to those described for the writing wavelength are also suitable at the reading wavelength. No absorption of the dye at the reading wavelength is also possible. In one embodiment, the read beam has a wavelength shifted from about 10 nm to about 500 nm from the signal beam's wavelength.

In some embodiments, the reading wavelength and the writing wavelength may be about 375 nm to about 830 nm. In other embodiments, the wavelength of light used for writing can be about 400 nm to about 550 nm, and the reading wavelength can be about 600 nm to about 700 nm. In yet another embodiment, a wavelength of 532 nm light can be used for writing and wavelengths of either 633 nm or 650 nm light can be used for reading. If the reading and writing wavelengths are the same, the wavelengths may be, for example, about 375 nm to about 830 nm. Specific read and write wavelengths are 532 nm and 405 nm.

Thus, to optimize the data storage media, the absorbance properties of the dye, the writing wavelength and the reading wavelength should all be considered.

The present disclosure is illustrated by the following non-limiting examples.

### EXAMPLES

Example 1. Radical polymerization of a polymer-bound dye with a visible light absorption maximum.

Preparation of acrylate/dye based photopolymer: A flask containing 10 g of 4-[N-(2-Methacryloylethyl)-N-methylamino]-4′-nitrostilbene (see preparation: Iain A. McCulloch, Macromolecules 1994, 27, 1697-1702), 49 g of low molecular weight Poly(methyl methacrylate) available from Aldrich (Mw˜15,000), 40 g of methyl methacrylate and 1 g of Irgacure® 784 photo-initiator available from Ciba is gently warmed with stirring to completely dissolve all the components. The resulting homogeneous mixture is degassed by placing the contents under vacuum and filling the flask with nitrogen 3 times, followed by placing 0.25 ml of this mixture between 2 glass slides separated by 200 μm spacers. The lambda max for the stilbene dye portion of this mixture in an acrylate mixture is approximately 427 nm and the Irgacure® 784 is designed to initiate polymerization using a 532 nm laser.

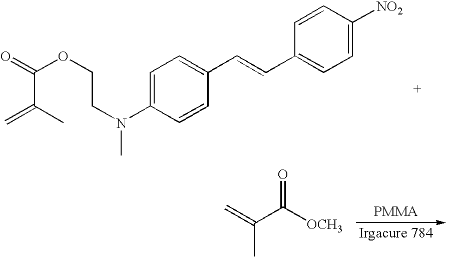

### Acrylate Mixture for Photopolymer Media

In this example, the dye has an absorption maximum that is below the write and read wavelengths. The write wavelength is 532 nm. The data can be read out at 532 nm or at higher wavelengths, if desired. The Irgacure 784 will cause the two monomers shown above to polymerize and move into the regions where the laser light constructively interferes. Initiator levels are 1 wt % to 3 wt % for this initiator based on the polymerizable moieties available. Ratios of monomers and poly(methyl methacrylate) may be varied.

### Example 2. CROP-type polymerization of epoxy monomers for involving near IR polymer-bound dyes.

In addition to radical polymerizations, polymer-bound dyes can be used in photopolymer based media. One type of dye can be synthesized following the procedure in Kubo; Y. Sasaki, K.; Yoshida K. Chem. Lett. 1987, 1563, shown below. Indoaniline dyes, such as the polymer-bound dye, 3, typically have a λₘₐₓ of about 590 nm to about 630 nm. Reaction of these dyes with a metal salt, such as nickel or copper perchlorate, results in a stable metal complex and shifts the absorption maxima to greater than 740 nm. This polymer-bound dye can be used as the binder in formulating holographic storage media. Due to miscibility issues, the dye may comprise less than or equal to about 50% of the total mass of the polymer-bound dye. 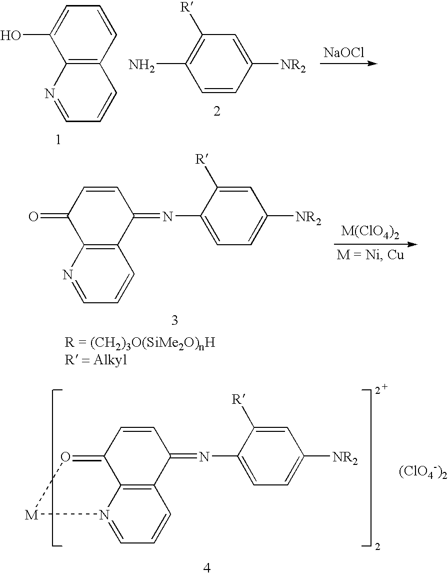
Synthesis of indoaniline metal complexes of copper and nickel.

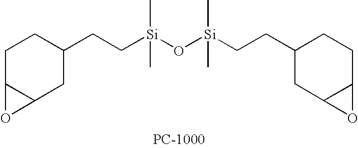

Once prepared, the polymer-bound dye is mixed with a bis-epoxy monomer, such as PC-1000 (Polyset Inc), a sensitizer, such as 5,12-bis(ethynylphenyl)naphthacene (Sigma-Aldrich), and an iodonium salt (GE Silicones). This mixture is sandwiched between glass slides, using plastic spacers to control the thickness of the material. A short exposure, typically 1 to 2 seconds, to an intense UV light source will cure, or harden, the liquid material, in order to prepare it for holographic writing. In contrast to the example 1, this dye molecule has long wavelength absorption maximum and holographic writing would be done at 532 nm. The absorption of the dye is significantly different than that of the sensitizer and/or photo acid generator, so as not to interfere with the photoinitiated polymerization.

A data storage medium comprising a polymeric binder, a photoactive monomer, a photo-initiator and a stable organic or organometallic dye has been described. An advantage of this system is that the dye can be associated with the binder phase or the photopolymer phase to enhance the refractive index difference between the phases. Increasing the refractive index difference can increase the dynamic range of the holographic storage material. Another advantage of the disclosed data storage medium is that data writing and reading may be performed at the same wavelength.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A holographic storage medium comprising:
a polymeric binder;
a photoactive monomer;
a photo-initiator; and
a stable, organic or organometallic dye;
wherein the dye is present in an amount sufficient to enhance the refractive index difference between a region of polymeric binder and a region of photopolymer.

2. The holographic storage medium of claim 1, wherein the dye is present in an amount of 0.1 percent by weight to 75 percent by weight of the total weight of the storage medium.

3. The holographic storage medium of claim 1, wherein at least a portion of the photoactive monomer is polymerized to provide an optically readable datum comprised within the holographic storage medium.

4. The holographic storage medium of claim 1, wherein the dye is covalently attached to the polymeric binder, the photoactive monomer, or both.

5. The holographic storage medium of claim 1, wherein the dye has an absorption maximum either greater than or less than a wavelength of light employed to initiate photopolymerization of the photoactive monomer.

6. The holographic storage medium of claim 1, wherein the polymeric binder is a polymethyl methacrylate, a copolymer of methyl methacrylate with an acrylic alkyl ester, a polysiloxane, a polysiloxane copolymer, a chlorinated polyethylene, a copolymer of vinyl chloride with acrylonitrile, a polyvinyl acetate, a polyvinyl alcohol, a polyvinyl formal, a polyvinyl butyral, a polyvinyl pyrrolidone, an ethyl cellulose, an acetyl cellulose, or a combination comprising one or more of the foregoing polymeric binders.

7. The holographic storage medium of claim 1, wherein the photoactive monomer is a monomer comprising a cyclohexene oxide grouping linked to an Si—O—Si grouping, a vinyl ether, an alkenyl ether, an allene ether, a ketene acetal, an epoxy, an acrylate, a methacrylate, a methyl methacrylate, an acrylamide, a methacrylamide, a styrene, a substituted styrene, a vinyl naphthalene, a substituted vinyl naphthalene, a vinyl derivative, or a combination comprising one or more of the foregoing photoactive monomers.

8. The holographic storage medium of claim 1, wherein the photo-initiator is p-octyloxyphenyl phenyliodonium hexafluoroantimonate, ditolyliodonium tetrakis(pentafluorophenyl) borate, diphenyliodonium tetrakis(pentafluorophenyl)borate, tetrakis(pentafluorophenyl)borate, cumyltolyliodonium tetrakis(pentafluorophenyl)borate, η 6-2,4-cyclopentadien-1-yl) (η 6-isopropylbenzene)-iron(II) hexafluorophosphate, or a combination comprising one or more of the foregoing photoinitiators.

9. The holographic storage medium of claim 1, wherein the photo-initiator is bis(η-5-2,4-cyclopentadien-1-yl)bis[2,6-difluoro-3-(1H-pyrrol-1-yl)phenyl]titanium, 5,7,diiodo-3-butoxy-6-fluorone, or a combination comprising one or more of the foregoing photoinitiators.

10. The holographic storage medium of claim 1, further comprising a sensitizer for the photo-initiator.

11. A method for producing a holographic storage medium comprising:
forming a substrate comprising a polymeric binder, a photoactive monomer, a photo-initiator, and a stable organic or organometallic dye; and
writing data into the substrate with an information-carrying light pattern, at a wavelength suitable to activate the photo-initiator and to polymerize at least a portion of the photoactive monomer to form the holographic storage medium;
wherein the dye is present in an amount sufficient to enhance the refractive index difference between a region of polymeric binder and a region of photopolymer.

12. The method of claim 11, wherein the dye is covalently attached to the polymeric binder, the photoactive monomer, or both.

13. The method of claim 11, wherein the dye has an absorption maximum greater than or less than the wavelength of light suitable to activate the photo-initiator and to polymerize at least a portion of the photoactive monomer.

14. The method of claim 11, wherein the wavelength of light which is employed to activate the photo-initiator is about 375 nm to about 830 nm.

15. The method of claim 11, further comprising:
covalently attaching a linker group to a reactive functional group on the dye to form a dye material comprising a covalently attached linker group; and
covalently attaching the dye material comprising a covalently attached linker group to the photoactive monomer, the polymeric binder, or both.

16. The method of claim 11, wherein the wavelength of light which is employed to activate the photo-initiator is different from a wavelength of a light beam utilized to read data from the holographic storage medium.

17. The method of claim 11, wherein the wavelength of light which is employed to activate the photo-initiator is the same as a wavelength of a light beam utilized to read data from the holographic storage medium.

18. A method for storing data in an optical storage medium comprising:
forming a storage medium comprising a polymeric binder, a photoactive monomer, a photo-initiator, and a stable, organic or organometallic dye; and
illuminating the storage medium with a signal beam possessing data and a reference beam simultaneously for storing a hologram of the data contained by the signal beam in the optical storage medium;
wherein at least a portion of the photoactive monomer undergoes polymerization upon exposure to the signal beam, thereby forming a hologram in the storage medium; and
wherein the dye is present in an amount sufficient to enhance the refractive index difference between a region of polymeric binder and a region of photopolymer.

19. The method of claim 18, wherein the dye is covalently attached to the polymeric binder, the photoactive monomer, or both.

20. The method of claim 18, further comprising exposing at least a portion of the storage medium having an area larger than the hologram to a wavelength of light sufficient to react an unreacted photo-initiator and to polymerize an unpolymerized photoactive monomer.

21. An optical reading method comprising:
forming a storage medium comprising a polymeric binder, a photoactive monomer, a photo-initiator, and a stable organic dye;
illuminating the storage medium with a signal beam possessing data and a reference beam simultaneously for storing a hologram of the data contained by the signal beam in the optical storage medium, wherein at least a portion of the photoactive monomer undergoes polymerization upon exposure to the signal beam thereby forming a hologram in the storage medium;
illuminating the holographic storage media with a read beam; and reading the data contained by diffracted light from the hologram;
wherein the dye is present in an amount sufficient to enhance the refractive index difference between a region of polymeric binder and a region of photopolymer.

22. The method of claim 21, wherein the signal beam has a wavelength of about 375 nm to about 830 nm.

23. The method of claim 21, wherein the read beam has a wavelength of about 375 nm to about 830 nm.

24. The method of claim 21, wherein the read beam and the signal beam have the same wavelength.

25. The method of claim 21, wherein the wavelength of the read beam is shifted by about 10 to about 500 nm from the wavelength of the signal beam.
